(19) United States
(12) Patent Application Publication
(10) Pub. No.: US 2008/0251352 A1
(43) Pub. Date: Oct. 16, 2008

(54) BUFFER FOR CLOSING GAPS IN PRODUCT FLOW, AND WRAPPING SYSTEM INCORPORATING SUCH BUFFER

(75) Inventor: Harry C. Noll, Macungie, PA (US)

Correspondence Address: LUCAS & MERCANTI, LLP, 475 PARK AVENUE SOUTH, 15TH FLOOR, NEW YORK, NY, 10016, US

(73) Assignee: MULLER MARTINI MAILROOM SERVICES, INC., Allentown, PA (US)

(21) Appl. No.: 12/052,409

(22) Filed: Mar. 20, 2008

Related U.S. Application Data
(60) Provisional application No. 60/896,363, filed on Mar. 22, 2007.

(51) Int. Cl. B65G 47/64

(52) U.S. Cl. 198/434

(57) ABSTRACT

A system receives flat products in a serial manner, transports them to a buffer apparatus, senses the presence of any significant gaps between adjacent products, passes the products to a wrapping or other processing machine and then removes the processed products from the system. The buffer closes gaps between adjacent products with an arrangement of fast and slower-moving chains or conveyors.

### STATEMENT REGARDING FEDERALLY-SPONSORED RESEARCH OR DEVELOPMENT

Not applicable.

### BACKGROUND OF THE INVENTION

1. Field of the Invention

This invention relates to a buffer apparatus for use in transporting flat products such as newspapers, magazines, inserts and the like from one area of a machine to another in a uniform flow, and more particularly to a buffer for closing gaps in the flow of flat products. The invention also relates to a combination wrapping system that incorporates such buffer.

2. Description of the Related Art

In many industries, such as the graphic arts and newspaper industries, newspapers and other flat products pass through several processing steps after they are printed. Typically, they are conveyed to an inserting machine where advertisements, flyers, etc. are inserted into folded newspaper jackets. Next, the inserted products are transported to other areas or machines by a conveying system. In some systems, if the products are being transported in a vertical, hanging orientation, a transfer wheel may be used to grab the papers, reorient them into a horizontal orientation, and lay them down flat on another conveyor.

In many applications, the papers also need to be wrapped or bagged with plastic, paper or other flexible wrapping material. A main purpose for wrapping the papers is to protect them from water and debris during delivery of the papers to customers. The sealed bag also prevents the inserts from falling out, and helps reduce the risk that a paper will be folded or crumpled during processing and delivery. The bag can also improve the appearance of the product, and can serve as a convenient surface for the printing of “onserts” such as messages, mailing labels, etc.

Some commercial wrapping machines are commercially available. Some of these machines can wrap papers at relatively high speeds. However, these wrappers are usually quite delicate and are not very “forgiving” of irregularities in the paper flow. For example, if there is a gap in the paper flow for some reason, some wrappers may stop, slow down or otherwise not function properly, especially if the product flow is very high. Other processing machines may also develop difficulties if a non-uniform flow were to occur.

Gaps can occur for several reasons. For example, if there is a problem upstream that causes a paper to be rejected or removed from the conveyor, a gap will appear in the paper flow. As used herein, the term “gap” means a gap between adjacent products moving in serial fashion that is at least as wide as the width of one product.

Thus, there is a need for an apparatus to close gaps in a product flow before the products reach a wrapper machine or other processing machine, so as to maintain orderly, uniform and rapid product flow into the wrapper for sustained high performance.

### SUMMARY OF THE INVENTION

The present invention satisfies the above-mentioned needs. If a gap is detected in a serial flow of flat products, the products on either side of the gap are speeded up or slowed down at particular points to close the gap by an arrangement of parallel chains or conveyors, some moving at a high speed and some moving at a lower speed.

More particularly, in one embodiment, the invention comprises a buffer apparatus for closing gaps in a flow of -flat products, comprising:

a first conveying means moving at a first linear speed and adapted to serially transport a plurality of flat products;

a second conveying means adjacent to the first conveying means, moving at a second linear speed and adapted to serially transport a plurality of flat products;

means for sensing the presence of a gap between adjacent products; and

means for transferring products from the first conveying means to the second conveying means and adjusting the second linear speed so as to close the gap.

In another embodiment, the invention comprises

An improved wrapping system for wrapping flat products, comprising means for receiving vertically-oriented products from an overhead conveyor, reorienting such products horizontally and passing such products serially to a buffer;

means associated with the buffer for sensing gaps between adjacent products;

means associated with the buffer utilizing two adjacent conveying means moving at varying speeds for closing the gaps and passing such products to a wrapping machine;

means for wrapping such products with Flexible wrap; and

means for removing wrapped products from the wrapping system.

### BRIEF DESCRIPTION OF THE DRAWINGS

These and other aspects of the present invention may be more fully understood by reference to one or more of the following drawings, in which:

FIG. 1 is a side view showing the external appearance of one embodiment of an overall wrapping machine assembly;

FIG. 2 is a perspective view of one embodiment of a buffer machine module of the invention;

FIG. 3 is an end view of the buffer module;

FIG. 4 is a side view of a transfer wheel or pacer wheel machine module of the overall wrapping system of FIG. 1;

FIG. 5 is a more detailed side view of the transfer wheel module of FIG. 4;

FIG. 6 is a perspective external view of a delivery wheel module of the overall wrapping assembly of FIG. 1;

FIG. 7 is a side view of delivery wheel module of FIG. 6;

FIG. 8 is a top view of the delivery wheel module of FIG. 6;

FIG. 9 is a perspective view of the delivery wheel module of FIG. 6 showing certain internal structures in more detail;

FIGS. 10-22 are a series of simplified side pictorial views of the buffer of the invention showing the operation of the buffer in a time sequence; and

FIG. 23 is a timing diagram showing a graph of the speed of products and gaps as they pass by different areas of the buffer.

### DETAILED DESCRIPTION OF THE INVENTION

The following is a description of one embodiment of the present invention that includes a buffer machine module for use in filling gaps in the flow of flat or approximately flat products such as newspapers, newspaper inserts, sheets, cards, signatures, magazines, books, disks, mail, film packages, etc. The buffer invention is particularly useful for closing gaps between adjacent products as they travel along a conveyor on their way toward a wrapping or bagging machine module. It is to be understood, however, that the buffer may be adapted for use in virtually any environment where the linear flow of flat or approximately flat products needs to be kept uniform, and in particular where each product needs to be spaced apart an equal or approximately equally distance from its adjacent products.

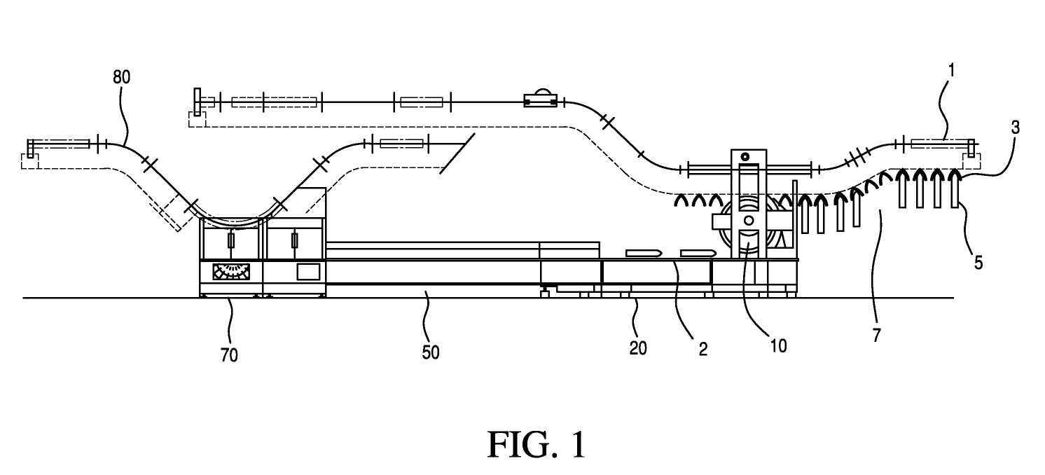

Turning now to the drawings, FIG. 1 is a side view showing the external appearance of one embodiment of an overall wrapping machine system. The system is a combination system that incorporates several different machine modules arranged generally horizontally and adjacent to one another. The modules operate in highly coordinated and timed fashion relative to one another. Products are linearly and serially transported at very high speeds from one module to the next using conveyors and wheels. In FIG. 1, the product flow is from right to left. In this particular embodiment, the overall system includes a transfer wheel or pacer wheel module 10 adjacent to a buffer module 20, which is adjacent to a wrapper or bagger module 50, which is adjacent to a delivery wheel or pickup drum module 70. Other modules or processing machines may also be included in the system, such as product feeders, rejectors, printers or others.

The flow of products in FIG. 1 proceeds generally as follows: First, an overhead gripper conveyor 1 picks up products 5 such as newspapers from an insert machine (not shown) or other processing machine. The gripper conveyor may be of conventional design. The products 5 are held by grippers 3 on the conveyor and hang vertically. Each gripper may not necessarily hold a product. For example, a problem may have occurred upstream that required a product to be rejected or removed from the conveyor. In such an event, a gap 7 will appear in the flow of products as they are carried along by the conveyor.

Next, in this embodiment, the products are conveyed to a transfer wheel or pacer wheel module 10, which is located at or near the beginning point of the overall wrapping system. The transfer wheel reorients the products from a vertical to a horizontal orientation and lays them down serially, in singulated fashion, onto another conveyor 2. Transfer wheel module 10 is the subject of a separate pending U.S. patent application Ser. No. 11/454,534 (now Patent Application Publication No. US-2007-0001381-A1) and owned by the assignee of the present invention. Such application is incorporated herein by reference.

After passing the transfer wheel, the products enter a buffer module 20 of the present invention, where any significant gaps in the product flow are closed (discussed in more detail below).

Next, the products are transported to a wrapping or bagging machine module 50, where each product is wrapped in thin plastic film or other flexible material, and then the film is sealed. Such wrapper modules are commercially available. In a preferred embodiment of the present invention, a wrapper module manufactured by C.M.C. S.p.a (Graphic and Mailing Division of the Ponti Group, of Italy) is used. The overall wrapping system integrates this wrapper module with other modules to form a relatively large, integrated combination system.

Although some commercial wrapper units are capable of wrapping products at relatively high speeds, and the speed may be varied, the flow of products into and out of the wrapper needs to be carefully controlled and kept uniform because products are flowing at high speeds, the wrapper may be “delicate,” and gaps in the product flow can cause serious interruptions or other problems to develop at the wrapper 50, even if the wrapper is temporarily slowed down. The purpose of the buffer 20 of the present invention is to close any gaps that might be present before the products are fed into the wrapper.

After exiting the wrapper, the wrapped products are conveyed to a delivery wheel or pickup drum module 70, where they are removed from the wrapping system and passed to an overhead pickup conveyor 80. Finally, conveyor 80 transports the products away to other processing machines, such as stackers or bundlers (not shown).

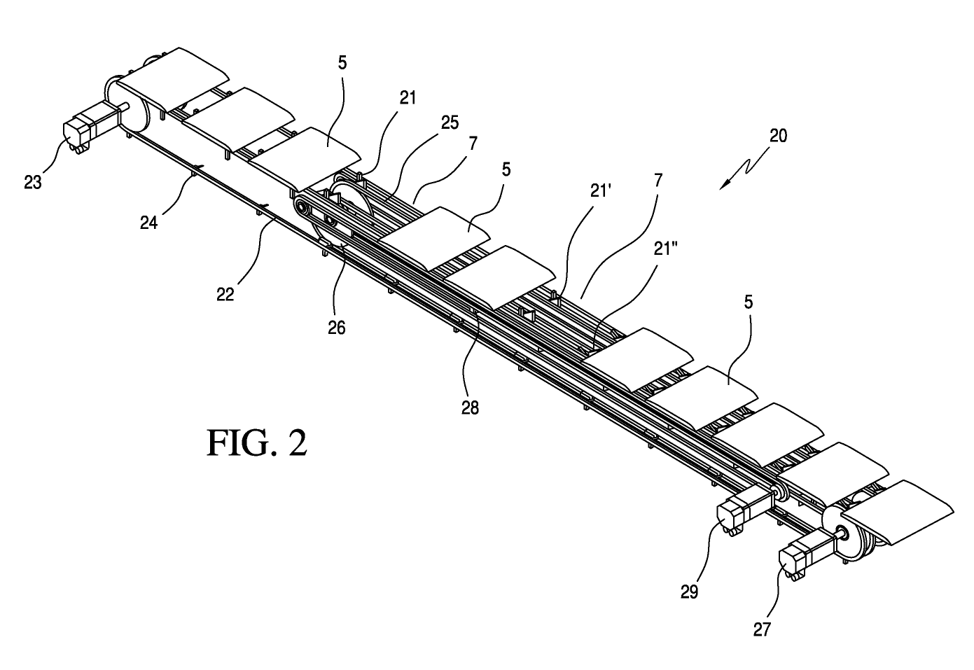

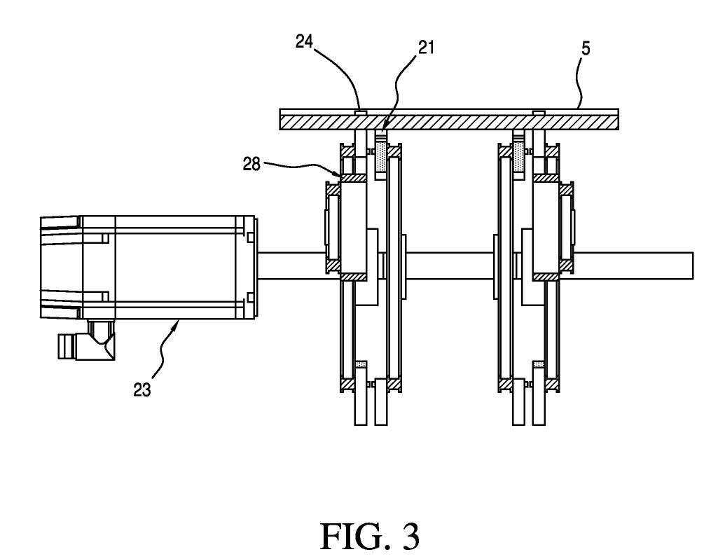

FIG. 2 is a perspective view of one embodiment of a buffer machine module 20 of the present invention, and FIG. 3 is an end view of buffer 20. Generally, gaps are closed in product flow by temporarily speeding up or slowing down products at different points as the products move along a path. In buffer 20, as shown in FIG. 2, inserted packages or other flat products 5 enter the apparatus on the left side and travel toward the right. The products are initially engaged by two or more parallel, horizontal pre-buffer chains 22 movably mounted within a frame (not shown). Chains 22 are driven at a constant linear speed by a pre-buffer server motor 23. Preferably, the linear speed of chains 22 is very high and is the same as the linear speed of the overhead gripper conveyor 1 (FIG. 1) that is carrying papers away from an insert machine (not shown).

Along each pre-buffer chain 22 are fixedly mounted a plurality of pre-buffer pusher lugs 24 at regular intervals. Lugs 24 are preferably spaced apart by a distance equal to the width of one product, plus a slight gap that is narrower that the width of one product. The lugs engage the trailing edges of the products and maintain them in place as the chains push the products along.

Between the two pre-buffer chains 22, there are mounted two or more parallel, horizontal, moving buffer chains 25, being driven at a variable linear speed by a buffer servo motor 27. The tops of buffer chains 25 are moving in the same direction as the tops of pre-buffer chains 22. Preferably the buffer chains move at the maximum speed at which wrapper module 50 (FIG. 1) can effectively accept and wrap products with plastic wrap without jamming, etc. In the case of newspaper products, if no gaps in the product flow are present, then the wrapper can normally wrap the newspapers at the same speed that an inserter can place inserts into the newspapers.

Along each buffer chain 25, a plurality of buffer pusher lugs 21 are pivotally mounted at regular intervals. Lugs 21 are preferably spaced apart by a distance equal to the width of one product, plus a slight gap that is narrower that the width of one product. Lugs 21 are arranged to pivot between an “up” position, shown at position 21′ of FIG. 2, and a “down” position, shown at position 21″ of FIG. 2. When in the “up” position, the lugs engage the trailing edges of the products and maintain them in place as the buffer chains push the products along. In the “down” position, a set of lugs 21 will permit their associated product to slide along or above the pre-buffer chains 21 for a short distance. This permits a fast-moving product to slow down, or a slow-moving product to speed up, as will be discussed below. The timing of the pivoting of lugs 21 is controlled by sensors and a control system (not shown).

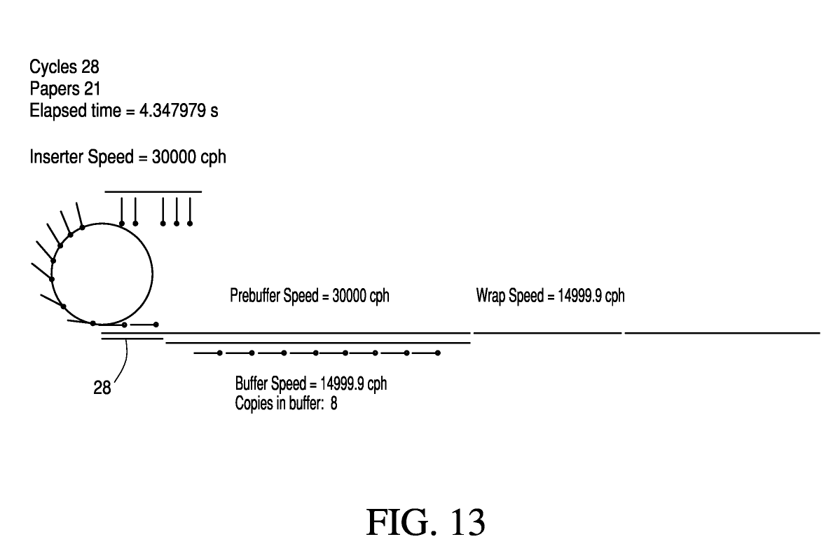

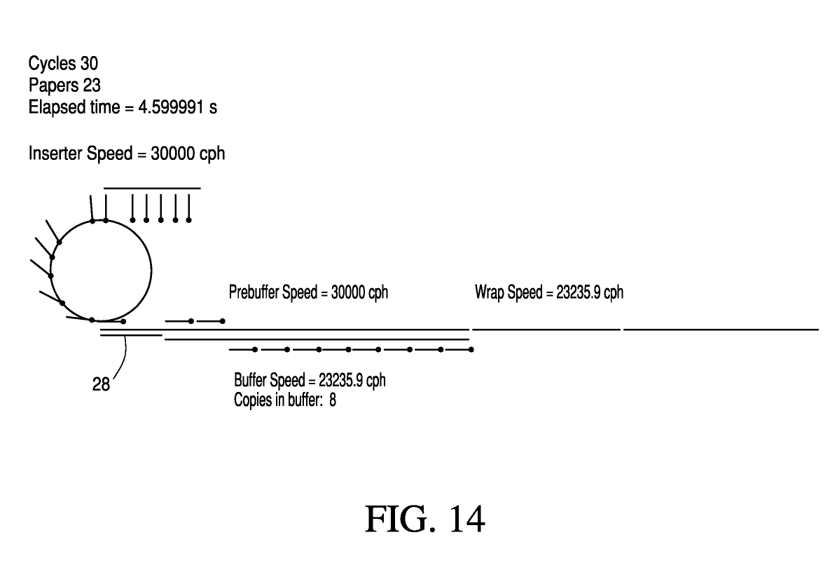

A “cam rail” device 28 is horizontally mounted slightly below and parallel to the pairs of chains 22 and 25. Cam rail 28 is arranged to reciprocate horizontally back and forth at timed intervals, driven by a chain driven by a cam rail servo motor 29. Timing of the reciprocating action is controlled by a control system (not shown). Reciprocating action of the cam rail can be seen by comparing FIG. 13 with FIG. 14. In FIG. 13, cam rail 28 is shown in its “retracted” position, namely moved toward the left. In FIG. 14, cam rail 28 is shown in its “extended” position, namely moved toward the right.

If no gaps are present in the product flow, the cam rail is normally kept retracted. If a product gap appears, the cam rail is extended to assist, in combination with a reduction in speed of the buffer chains 25, a reduction in speed of the wrapper, and pivoting of the buffer lugs 21, to close the gap by causing faster-moving products to “catch up” with slower moving products in front of them, thus closing the gap. When the gap has been closed, the cam rail is retracted and the lugs 21 are pivoted again to prevent the faster moving products from “crashing” into the slower moving products.

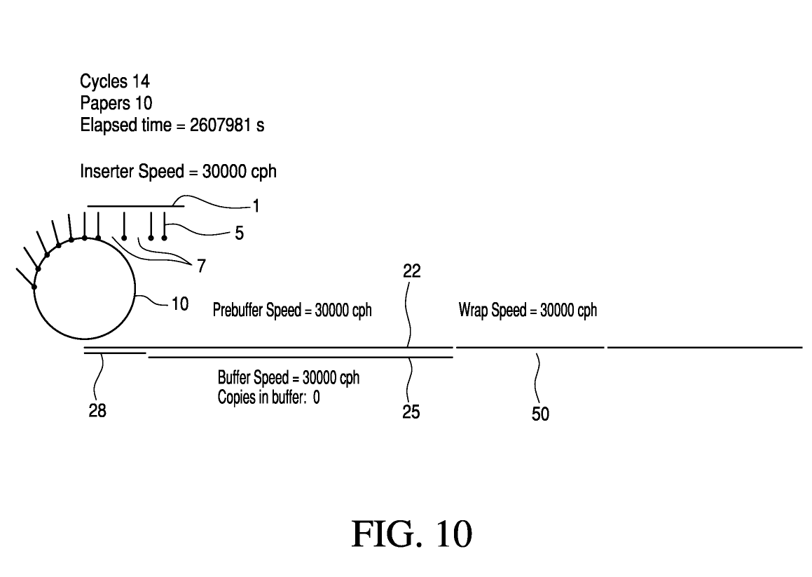

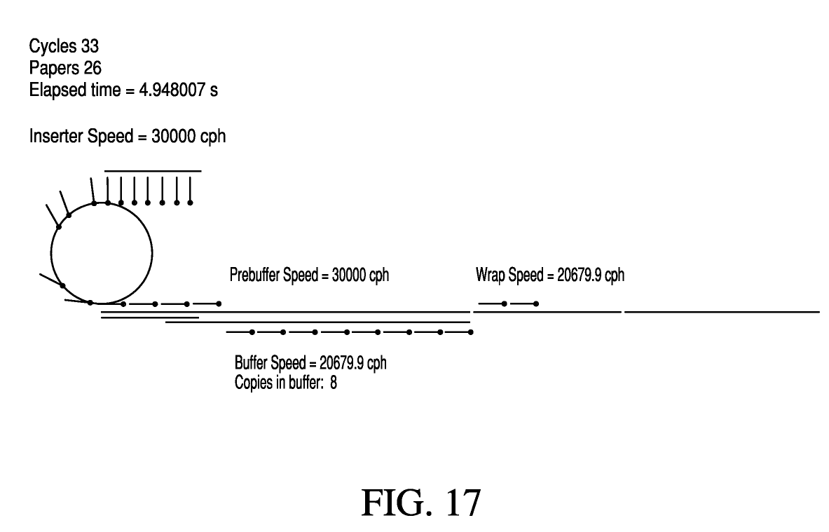

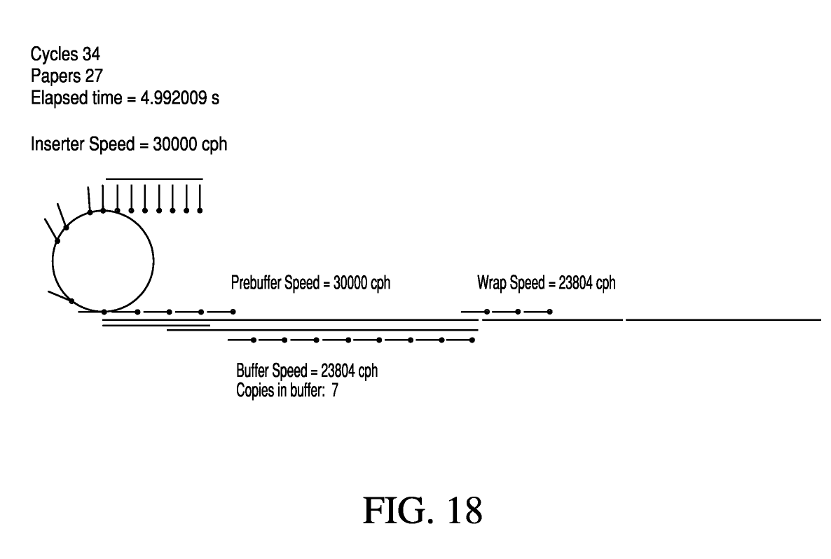

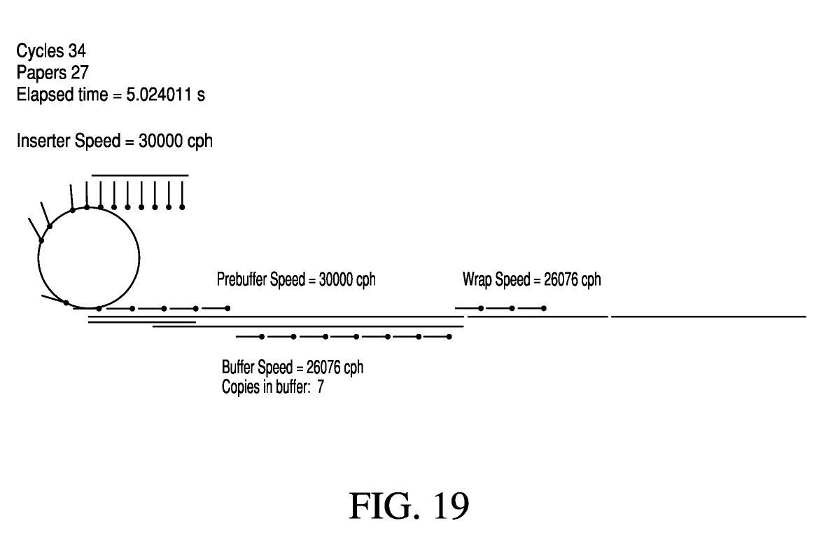

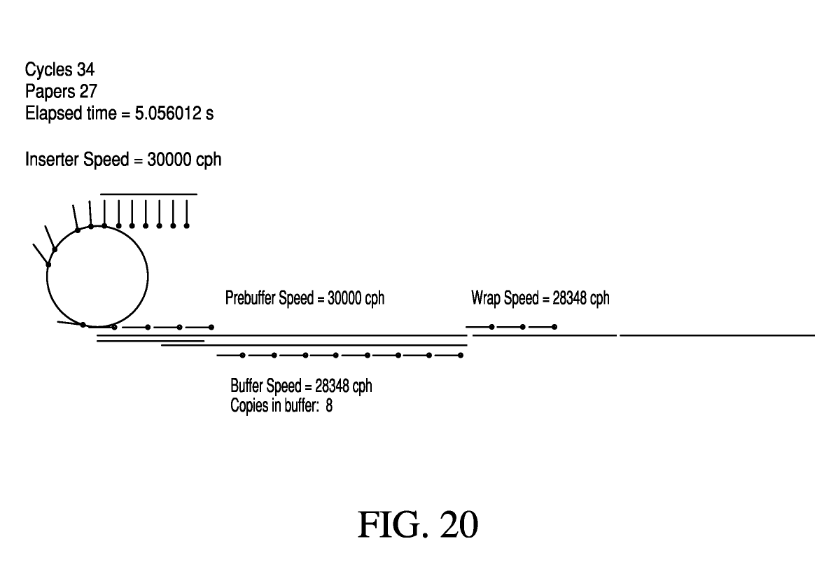

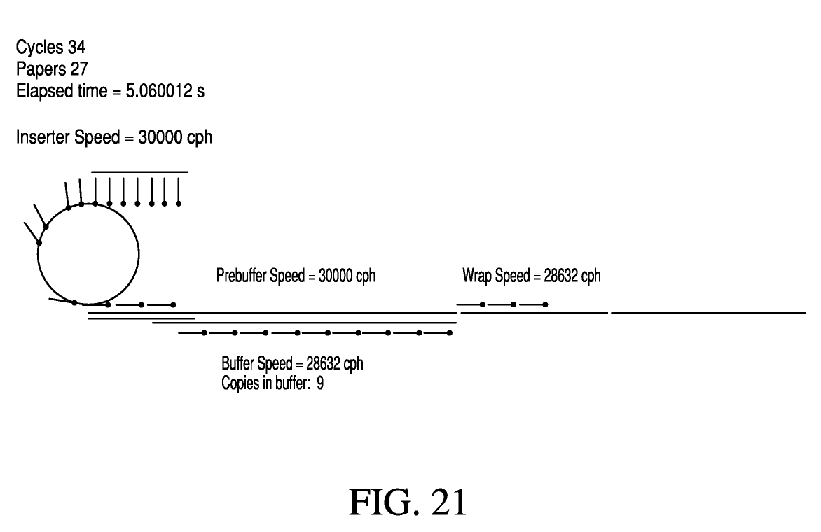

The operation of the buffer 20 will now be described. This is best illustrated in the time sequence diagrams shown in FIGS. 10-22. In FIG. 10, vertically-hanging products 5 are shown being delivered by overhead gripper conveyor 1 to pacer wheel 10. It can be seen that two gaps 7 have developed in the product flow.

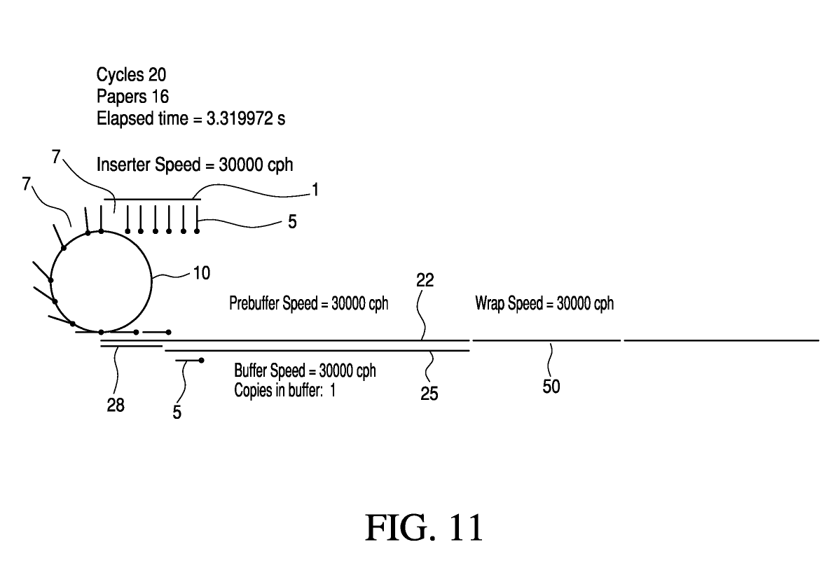

In FIG. 11, the pacer wheel has reoriented the products from vertical to horizontal and has begun to lay them down on the prebuffer chain 22. One product has also already entered the buffer area (defined by buffer chains 25). At this point, the pre-buffer chains are moving at the same speed as the buffer chains, and all chains are moving at the same speed as the wrapper. Although gaps still remain in the product flow, this is not yet a problem. The first gap is between the 7^{th} product and the 8^{th} product.

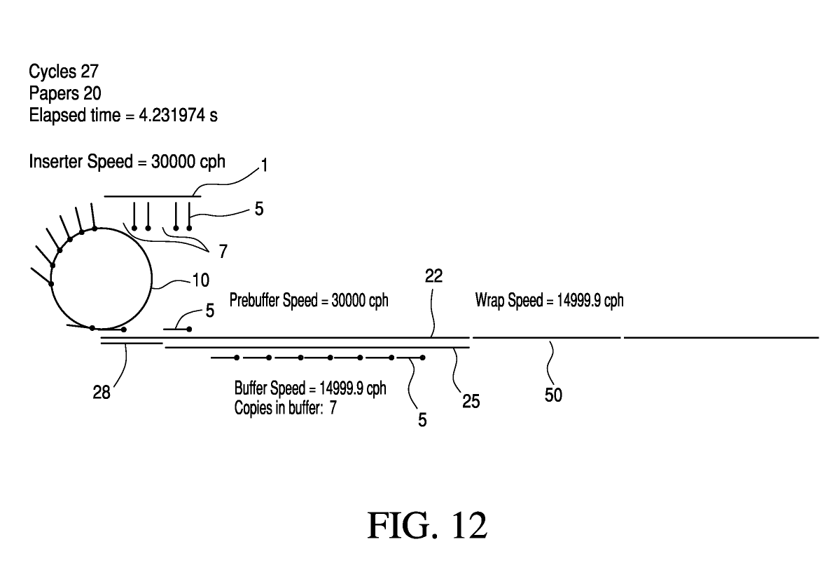

In FIG. 12, the first gap has appeared on the prebuffer chains. This gap has been sensed by one or more sensors (not shown), and a control system (not shown) has slowed down the wrapper and the buffer chains in preparation for closing the gap. The cam rail is also starting to be extended toward the right. At this point, since the 8^{th} product is moving faster than the 7^{th} product in front of it, the 8^{th} product has started to catch up with the 7^{th} product, and the gap is closing.

As can be seen In FIG. 13, the gap between the 7^{th} and 8^{th} product has now been completely closed.

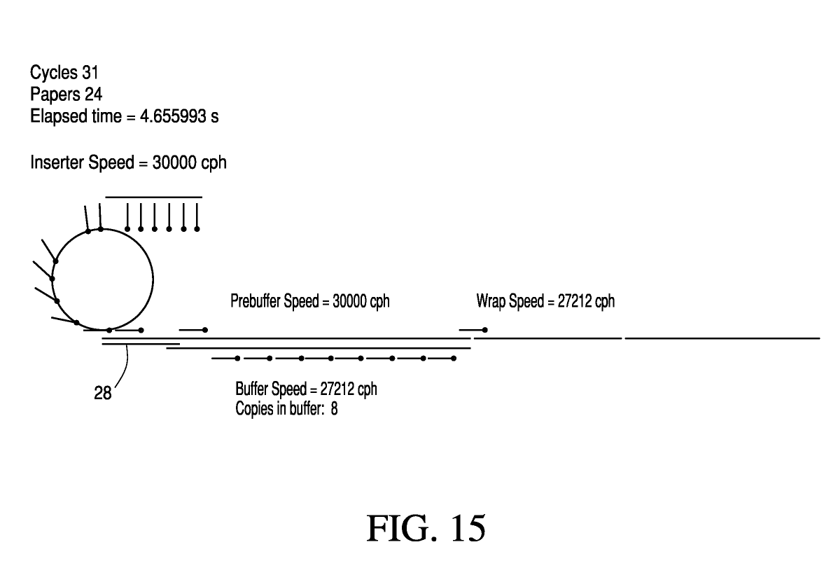

In FIG. 14, a second gap has been sensed. In FIG. 15, the first product has entered the wrapping machine. The wrapping machine is still moving slower than the prebuffer chain because of the sensing of the second gap.

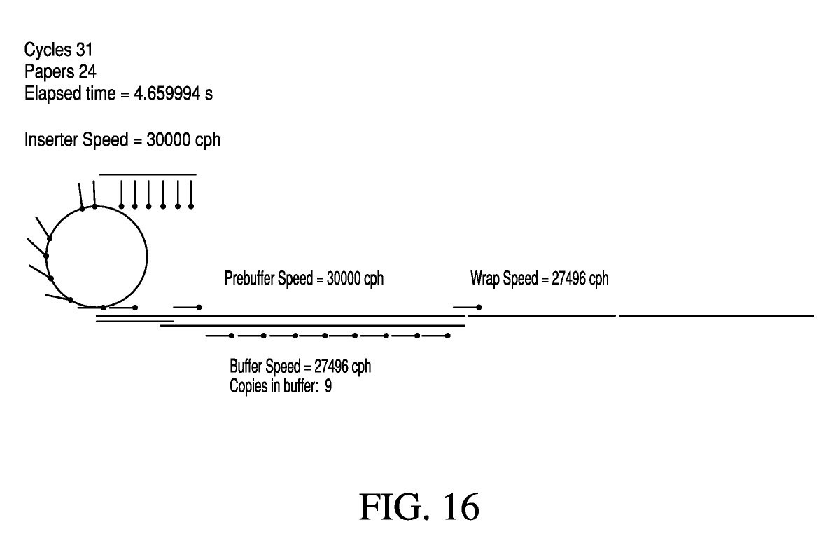

In FIGS. 16-21, the second gap is shown being closed.

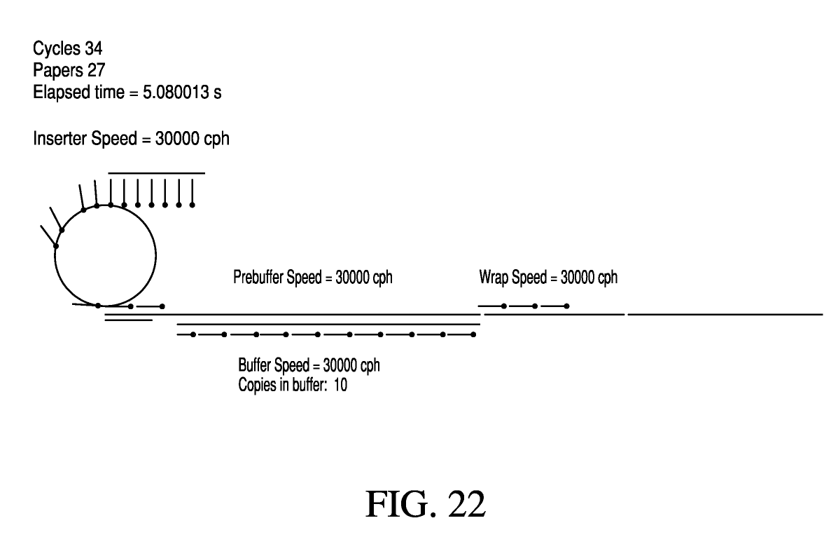

In FIG. 22, it can be seen that both of the first two gaps have now been completely closed; both the wrapper and the buffer chains have been returned to their normal, high, equal speeds; the cam rail has been retracted; and wrapping is continuing normally.

Later arriving gaps will be closed in similar fashion, even if a gap between adjacent products is greater than the width of one product.

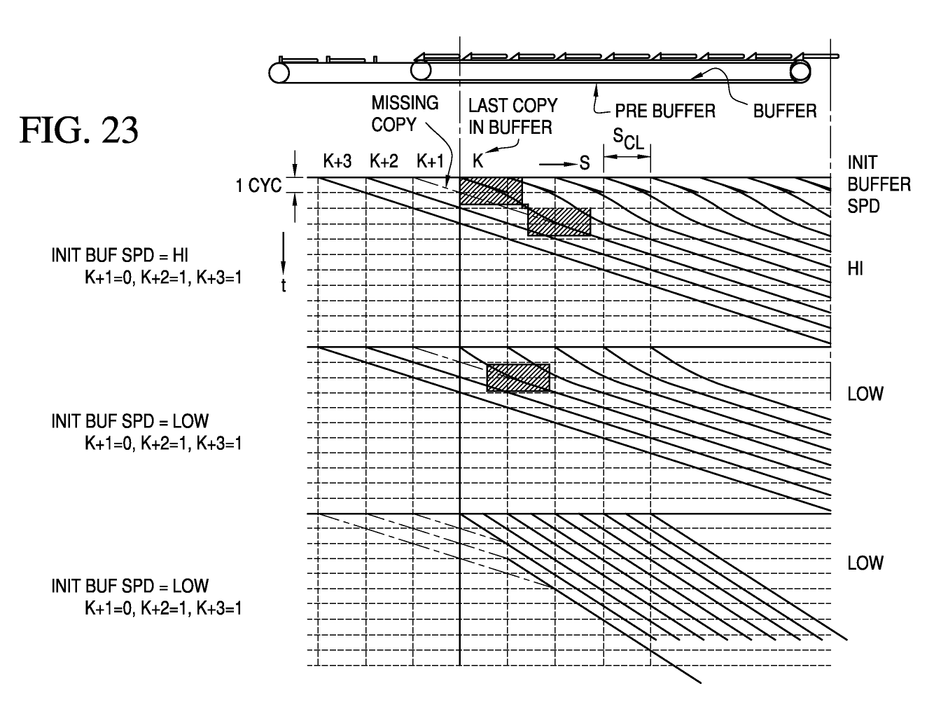

FIG. 23 is a timing diagram showing the speed of products and gaps as they pass by different locations on the pre-buffer chains and buffer chains.

Other modules of the overall wrapping system of FIG. 1 will now be briefly described.

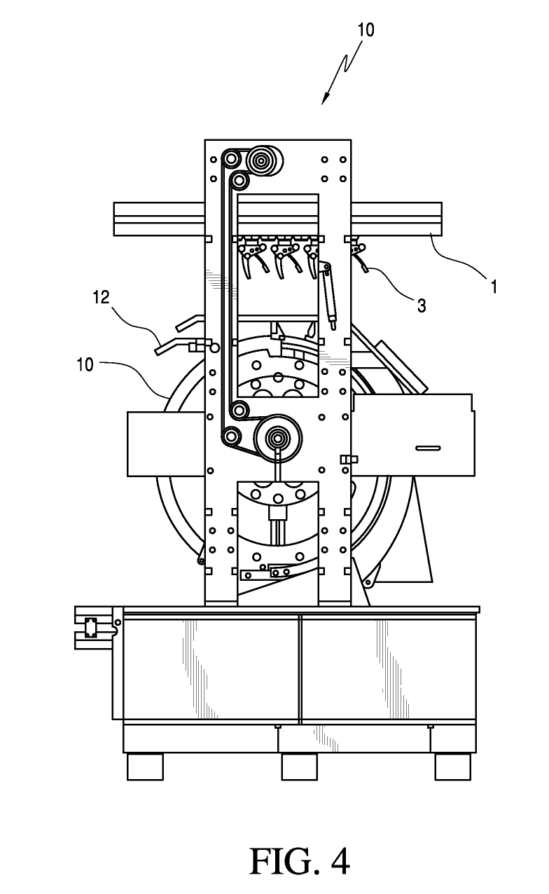

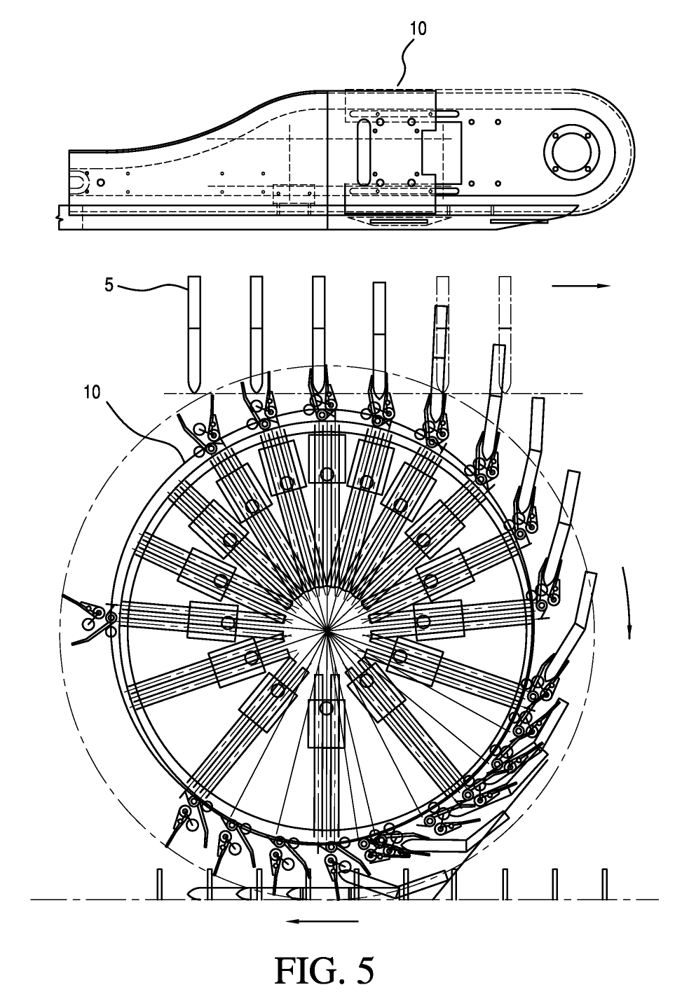

FIG. 4 is a side view of a transfer wheel or pacer wheel machine module 10 of the overall wrapping system of FIG. 1, and FIG. 5 is a more detailed side view of the transfer wheel. This wheel is preferably mounted upstream of the buffer module 20 and the other modules of the system. As previously noted, wheel 10 is the subject of prior pending U.S. patent application Ser. No. 11/454,534 (now Patent Application Publication No. US-2007-0001381-A1) and owned by the assignee of the present invention. Such application is incorporated herein by reference. Such application contains a detailed description of the structure and operation of the wheel, which need not be repeated here. It is noted that, in the present system, a drag rail 12 is included that is not discussed in the prior application. Drag rail 12 may be raised or lowered. In its raised position, products will be diverted away from wrapper 50. This is useful if, for some reason, a particular “run” of products does not need to be wrapped. By diverting the product flow, plastic wrap is saved.

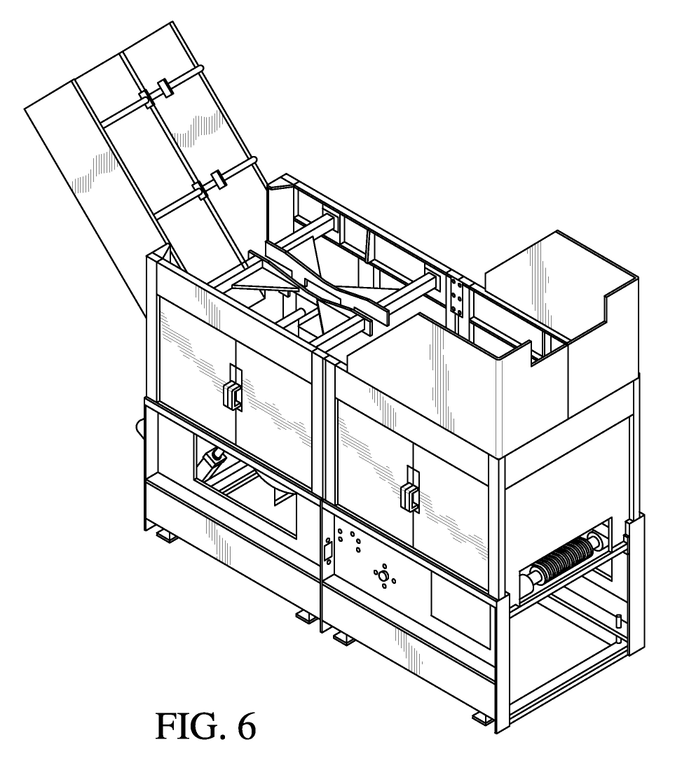

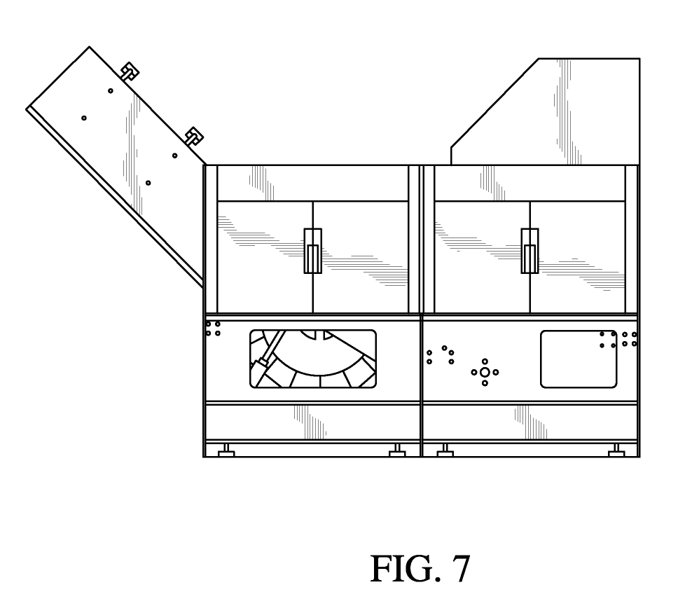

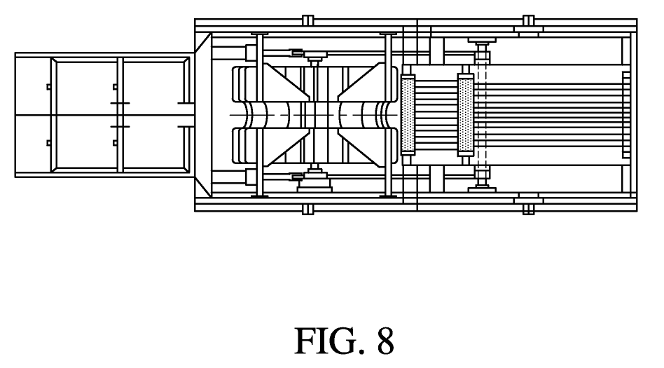

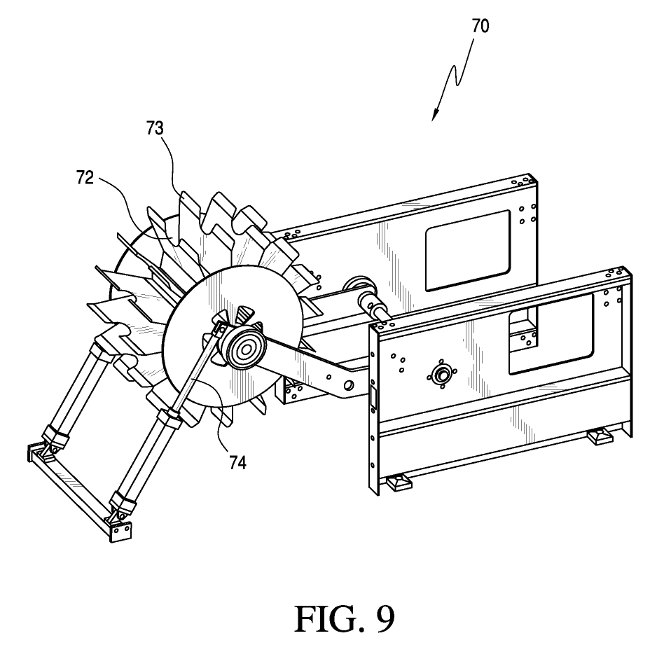

Another module included in the overall wrapping system is a delivery wheel or pickup drum module 70, which is shown in FIGS. 6-9. Preferably, module 70 is mounted downstream and approximately adjacent to wrapper module 50. A short conveyor extends between modules 50 and 70 (see FIG. 8). The purpose of the delivery wheel 70 is to remove wrapped packages from the wrapping system and deliver them to an overhead pickup conveyor 80 (FIG. 1). Grippers (not shown) on the pickup conveyor pass through notches 72 (FIG. 9) in the blades 73 of the pickup drum to grab the wrapped packages and carry them away. A wheel arm 74 allows the pickup drum to be raised or lowered if redirection of the product flow is desired.

Although only a few embodiments of the present invention have been expressly disclosed, the invention is, nonetheless, to be broadly construed, and is not to be limited except by the character of the claims appended hereto.

What is claimed is:

1. A buffer apparatus for closing gaps in a flow of flat products, comprising:
a first conveying means moving at a first linear speed and adapted to serially transport a plurality of flat products;
a second conveying means adjacent to the first conveying means, moving at a second linear speed and adapted to serially transport a plurality of flat products;
means for sensing the presence of a gap between adjacent products; and
means for transferring products from the first conveying means to the second conveying means and adjusting the second linear speed so as to close the gap.

2. An improved wrapping system for wrapping flat products, comprising:
means for receiving vertically-oriented products from an overhead conveyor, reorienting such products horizontally and passing such products serially to a buffer;
means associated with the buffer for sensing gaps between adjacent products;
means associated with the buffer utilizing two adjacent conveying means moving at varying speeds for closing the gaps and passing such products to a wrapping machine;
means for wrapping such products with flexible wrap; and
means for removing wrapped products from the wrapping system.
